(19) United States
(12) Patent Application Publication
(10) Pub. No.: US 2004/0012677 A1
(43) Pub. Date: Jan. 22, 2004

(54) Apparatus and method for processing images

(75) Inventor: Hans-Georg Schindler, Holzkirchen (DE)

Correspondence Address: DARBY & DARBY P.C., P. O. BOX 5257, NEW YORK, NY, 10150-5257, US

(73) Assignee: AGFA-GEVAERT AKTIENGESELLSCHAFT, Leverkusen (DE)

(21) Appl. No.: 10/423,853

(22) Filed: Apr. 25, 2003

(30) Foreign Application Priority Data
Apr. 30, 2002 (EP) 02009754.9

(51) Int. Cl. H04N 5/225

(52) U.S. Cl. 348/207.2

(57) ABSTRACT

The present invention relates to an apparatus and method for processing the images (B1-B7) of a photographic order. The image processing is controlled by a control means (SM). Determination means (FM) determines the presence or absence of at least one selected property (PAN, RA, DCD) of at least one of the images (B1-B7) of the photographic order. Sorting means (AS) automatically rejects an image (B1-B7) from the image processing procedure in the event that the presence or absence of the selected property (PAN, RA, DCD) cannot be determined unambiguously.

The present invention relates to an apparatus and method for processing the images of a photographic order.

### BACKGROUND OF THE INVENTION

DE 199 21 418 A1 discloses an apparatus and method for processing the images of a photographic order. Digital image data of the images of a photographic order are supplied to a known photographic system. This digital image data is subsequently passed on to control means which processes the digital image data with certain processing algorithms. The individual images are analyzed and the presence or absence of certain properties of the images is determined. In so doing, it can be determined, for example, whether the image is overexposed or underexposed, or a person in the image has red eyes resulting from the use of a flash. After the properties of the individual images have been determined, they can be corrected by means of the processing algorithms. This correction is completely automatic. The corrected image data of the individual images is transferred to an output means which prints or stores the images or the image data assigned to them. For example, the output means may be a digital printer which exposes the images on photographic paper. Likewise, the image data may be stored on a CD-ROM.

It is an object of the present invention to provide an apparatus and method for processing the images of a photographic order in a simple and efficient way without sacrificing quality.

### SUMMARY OF THE INVENTION

Pursuant to the invention, the presence or absence of a particular property of an image is determined. If the property of one of the images cannot be determined unambiguously, the image is rejected, i.e., automatically removed from the photographic processing process through which it otherwise would have passed. Such properties may be any of those which an image of a photographic order may have, such as the presence of red eyes resulting from the use of a flash, the existence of undesirable color tinge, fuzziness, underexposure or overexposure of individual images or possibly of whole orders, the format of the image (particularly whether it is a 35 mm full-size format or a 35 mm panoramic format) or the image orientation, which is relevant when the image data of the photographic order is stored on a CD.

According to the invention, images for which the correct and optimum processing is not necessarily assured because of an ambiguous property, are rejected. The rejected images are then subject to a more thorough examination in order to determine the presence or absence of the particular property. The processing of the images of the photographic order can be optimized and its quality raised. Incorrect processing of the images or improper correction of certain properties of the images on the basis of an incorrect identification of such properties can be avoided. Since the rejection of the images takes place automatically pursuant to the invention, it is possible to optimize the use of personnel during the processing of the images. Those images in which certain properties are doubtful, can be later processed efficiently.

In a preferred embodiment of the invention, a rejected image is transferred to a display device. The image can be shown on the display device and checked by an operator. Only those images having ambiguous properties are passed on to the operator. It is not necessary for the operator to check all images of a photographic order for the presence or absence of the property. For simplicity, the display device may be a monitor. The invention may employ several display devices which can be viewed by several operators.

Preferably, processing means for manually processing the rejected image are provided. With these, the operator can easily correct the rejected image(s) or, for example, mark positions on the rejected image which are subject to processing by the control means.

In a preferred embodiment of the invention, the degree of ambiguity or uncertainty required to trigger rejection can be set. This degree of ambiguity then serves as a criterion for rejecting the image. This means that if, for example, during the evaluation and assessment of the respective image up to a particular probability corresponding to the set degree of the lack of certainty, the presence of a particular property of the image is detected, further processing of this image is directed to processing means assigned to such property. If the probability that this property might not be present in the image does not reach the set degree of the lack of certainty, further processing of the image occurs in a different way intended for situations where the image does not have such property. According to the invention, it is possible to set the degree of lack of certainty so that it is variably adjustable. This can be done automatically, further increasing flexibility. It is thus possible to adapt to particular circumstances in a simple and effective manner. For the sake of simplicity, the degree of lack of certainty can be established by threshold values.

If it is a certainty that the image is not to be printed, it is not necessary that the image be checked by an operator on a monitor. For example, if it is determined with certainty that the image is very unsharp and, therefore, should not be printed, it is not necessary for a person to determine whether the picture also has “red eye” even if that property cannot be determined unambiguously. Similarly, if it is determined with certainty that the property of “red eye” is present in the image but the photographic process is unable to correct “red eye” automatically, the image must be rejected so that it can be corrected manually by the operator in front of the monitor. Accordingly, in accordance with a further embodiment of the invention, in addition to determining whether a particular property is or is not present, image rejection may occur as a function of a further specified criterion. In this way, an image may be rejected even though it was possible to establish with certainty that the property was present or absent. Furthermore, it is possible not to reject the image, although the presence or absence of the property was not detected with certainty. An increase in flexibility can be ensured by these means. The processing of images of a photographic order can be varied on a case by case basis depending on different factors as explained below.

The rate at which the images are rejected can be fixed. In this way, more or fewer images can be rejected depending on the situation. Moreover, the rejection rate can be fixed automatically. For example, a rejection rate can be selected depending on the availability of an operator. In this way, a good compromise can be established between the efficient use of an operator and the number of images which have been processed qualitatively in a high-grade manner. It is also possible to fix the rejection rate by correspondingly high or low threshold values, or to employ a combination of different criteria for fixing the rejection rate.

The rejection of the images can be suspended if the control means requires that the images of the photographic order be processed further. In this way, it is possible to utilize the system capacity optimally during the processing of images and also to optimize the use of the output means, particularly the digital printer used to expose photographic paper. Preferably, the output of images by the output means should not be interrupted because too many images have been rejected and therefore are unavailable for further processing by the output means.

By establishing priorities for the different properties to be tested for image rejection, further optimization and effective processing of the images is possible. For example, it is possible to establish that images having an assigned high rejection priority are rejected before images having an assigned lower rejection priority. This can lead to an optimum compromise between the use of the output means for producing the images, and the generation of a large number of images which are qualitatively high-grade. Establishing priority can be combined with establishing the degree of the lack of certainty, especially by establishing threshold values.

The automatic processing of the images of a photographic order involves a determination of the existence of certain properties, the correction of the image data depending on those properties, and the printing of the image data. An image will not be printed if certain criteria are not met. As used herein, the term “rejecting an image” means to reject or withdraw the image from the automatic image processing process (including the determination of whether or not to print); it does not mean that the image is not printed.

### THE DRAWINGS

In the following, the invention and its advantages are described by means of examples and drawings, in which

FIG. 1 shows diagramatically a first embodiment of the invention;

FIG. 2 shows an example of a particular property of an image and the establishment of thresholds for establishing the presence or absence of the property;

FIG. 3 shows an example of images to which different priorities for rejection are assigned; and

FIG. 4 shows an example of rejected images, ordered according to assigned priorities.

### DETAILED DESCRIPTION

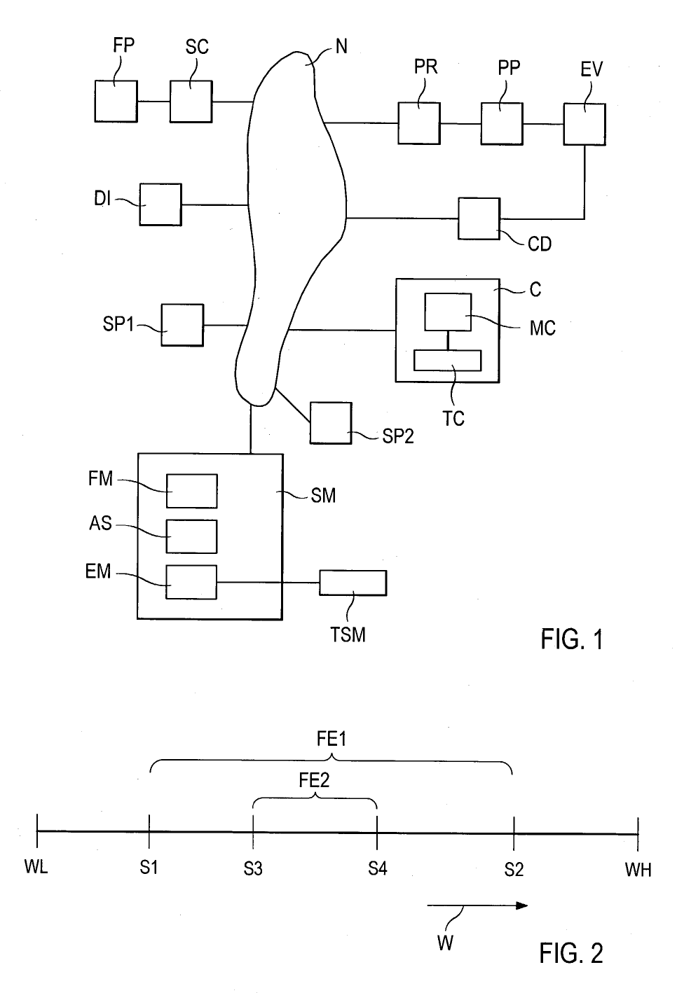

FIG. 1 shows a typical photographic system in a photo-finishing laboratory. The system contains various devices for inputting photographic orders. The input devices may include a film developer FP for developing photographic film and a scanner SC connected to the film developer for scanning the developed photographic film. The system may also contain a digital input interface DI for the input of digital image data. The digital input interface may, for example, be an interface to a network, such as the Internet, or a CD reading station for reading CDs. Other input interfaces for the input of photographic orders are possible.

The scanner SC and the digital input interface DI are connected to a network N. The scanner SC generates digital image data corresponding to the photographic images scanned. For example, this may refer to image information contained in photographic negatives. The image data, generated by the scanner SC or the digital image data input into the system over the digital input interface, are processed in the system. The digital image data can be stored temporarily in a first memory SP1, which is connected to the network N. In the present example, image data, processed by means of an image processing step, is already stored in a first memory SP1.

The processing of the digital image data is controlled by control means SM which is also connected to the network N. The control means SM controls the general processing of the photographic order input into the system. This includes, among other things, the distribution among the system components of the digital image data belonging to the respective photographic orders. The control means SM is used to process the digital image data by means of certain specified processing algorithms. For this purpose, memories (not shown) in which the processing algorithms are stored and to which the control means can resort in order to retrieve the processing algorithms are included in the system. The processing algorithms may comprise, for example, a so-called fuzzy masking of the image information of the individual images, a correction of underexposure or overexposure, a correction of fuzziness, a correction of red eye occurring in flash photography and/or image enlargement. Moreover, it is possible to make resolution or format changes to the individual images by means of the processing algorithms. Various properties of the individual images of the respective photographic order can be corrected or changed by means of the processing algorithms.

The control means includes determination means FM for determining the respective properties of the images. The digital image data of the individual images can be analyzed by means of the determination means in order to examine and ascertain the respective properties of the image. The determination means FM determines, for example, whether red eye and/or fuzziness are contained in an image. In so doing, the problem arises that the presence or absence of a particular property, such as the presence of red eye, cannot be determined unambiguously. Accordingly, the probability of whether the particular property is or is not present in the image is determined. For this purpose, threshold values are established which specify certain probabilities for which it is likely that a particular property is present or likely that a particular property is not present. The control means SM contains setting means EM for setting this threshold. A keyboard TSM is connected to the setting means EM so that an operator can enter the threshold values over the keyboard TSM into the control means SM.

Depending on the various thresholds established for determining the presence or absence of a particular property of an image, certain probabilities of the presence or absence of the property cannot be assigned unambiguously. Therefore, in the case of such probabilities, there is the danger of a greater or lesser magnitude that an image will be processed improperly with a particular processing algorithm, although this will not necessarily occur. Processing, when carried out improperly, can lead to deterioration in the quality of the image.

Pursuant to the invention, therefore, the control means SM contains a sorting means AS which automatically rejects images for which a particular property cannot be established unambiguously. Such a rejected image is then taken out of the normal processing cycle of the photographic system. Because of the rejection by the sorting means AS, the rejected images or rather their digital image data, are stored in a second memory SP2 connected to the network N in a particular sequence. The interim storage in the second memory SP2 is for the purpose of transferring the rejected digital image data, when required, to an inspection station C. The inspection station C is also connected to the network N. The inspection station C contains a monitor MC and a keyboard TC operated by an operator. The individual rejected images are displayed on the monitor MC. At the inspection station C, the operator looks at the image and decides whether, and, optionally, how the image is to be corrected by means of appropriate instructions entered by keyboard TC. On the basis of the image presented on the monitor MC, the operator is in a position, for example, to determine whether red points, recognized automatically in the system, are or are not to be corrected as the red eyes of an imaged person. By means of the keyboard TC or a mouse the operator is in a position to give appropriate instructions in regard to the area of the image shown in which there are red eyes. For example, by means of a particular processing algorithm, the system can appropriately correct the regions of the image which have been designated by the operator.

The system contains various output means for outputting images onto output media. For example, the system contains a digital printer PR which is connected to the network N. The digital printer PR exposes image information contained in the digital image data supplied to it on photographic picture in order to produce a photographic image. A paper developer PP is connected to the printer PR for developing the photographic paper. Final processing EV, connected to the paper developer PP, serves to cut the photographic paper sheets from the paper developer PP, and to sort the cut paper images according to the photographic orders entered into the system. Additional digital printers and paper developers may be present in the system. Furthermore, the system may contain a CD station CD. CD-ROMs, on which the digital image data of the individual photographic orders is stored, may be burned in station CD.

Usually, the digital image data which were automatically processed by the control means SM and may have been produced previously, for example, by the scanner SC, are supplied to the printer PR and/or the CD station. Therefore, in the event that the presence or absence of a particular property has been determined with sufficient certainty by the control means SM, there is no output of the digital image data to the second memory SP2 and to the inspection station C. Instead, the digital image data is processed directly by the control means SM with the appropriate processing algorithms and subsequently passed on over the network N to the printer PR and/or the station CD. If, for example, red eye has been detected reliably in an image by the determination means FM, it can be corrected automatically and appropriately by the control means SM. The corrected image data subsequently is supplied over the network to the printer PR for output onto the photographic paper.

FIG. 2 shows an example of a particular property of an image. In this case, the particular property is the presence of a 35 mm panoramic format. In the example of FIG. 2, the probability of the presence of the panoramic format is plotted in the direction of the arrow W. This means that at point WL which is plotted at the left edge of the representation, the probability is 100% that the format is a conventional 35 mm full-size format and not a panoramic format. At point WH which is at the right edge of the representation, the probability is 100% that the 35 mm format is a 35 mm panoramic format. Between the left point WL and the right point WH, there are certain probabilities for the presence of the panoramic format. These probabilities are determined by a processing logic, which is not essential to the invention and is not explained here.

In FIG. 2, a first threshold S1 has been drawn, which is to the right of the left point WL. A second threshold S2 is shown between the first threshold S1 and the right point WH. The first threshold S1 and the second threshold S2 are fixed for the control means SM by the operator, using the keyboard TSM. The property determination means FM determines the presence of a 35 mm full-size format for the probabilities which lie between the left point WL and the first threshold S1. The determination means determines the presence of a 35 mm panoramic format for the probabilities which lie between the second threshold S2 and the right point WH. In a region FE1 of the probabilities which lie between the first threshold S1 and the second threshold S2, the determination means FM cannot determine unambiguously whether a full-size format or a panoramic format is present in the image examined. Identification of a panoramic format is important, particularly in the case of very underexposed images. The recognition of the panoramic format may be particularly advantageous because, in comparison to the full-size format, the panoramic format can be processed further with a different resolution. Moreover, for a panoramic format, it may be advantageous to move stray light protection into the beam path of the scanner, unless the stray light of the imaging optics of the scanner is sufficiently low.

In order to prevent erroneous processing of a full-size format image or a panoramic format image, the image is rejected from the workflow of the conventional processing if the panorama identification logic of the processing algorithms of the control means SM determines a probability in the region FE1. The rejected image is passed onto the inspection station C, so that an operator can determine whether it is a full-format image or a panoramic format image. The region FE1, in which certainty with regard to the format of the image is lacking, is relatively large here, so that a relatively large number of images is rejected. At the same time, however, it is ensured that a large number of images is actually processed correctly; therefore, high quality is assured for the images produced.

If the number of rejected images is to be reduced so that a larger number of images are processed without being passed to the inspection place, it is possible to change the threshold for determining the probability range that lacks certainty. This change can be made, for example, by an operator using the keyboard TSM. It is also possible to have the threshold set automatically by the system. This can be done, for example, by specifying the number of images which can be stored in the memory SP2. When this number is reached, the thresholds are adjusted by the control means SM so that fewer images are rejected by the sorting means AS. In FIG. 2, a second region FE2 is shown in which there is a lack of certainty for determining the panoramic format. This second region FE2 is fixed by a third threshold S3 and a fourth threshold S4. In the region between the left point WL and the third threshold S3, the determination means FM will determine the presence of a 35 mm full-size format. In the region between the fourth threshold S4 and the right point WH, the determination means FM will determine the presence of a 35 mm panoramic format. The images for which the panoramic format identification logic determines a probability in the region of uncertainty FE2 will be transferred by means of the sorting means AS over the second memory SP2 to the inspection station C.

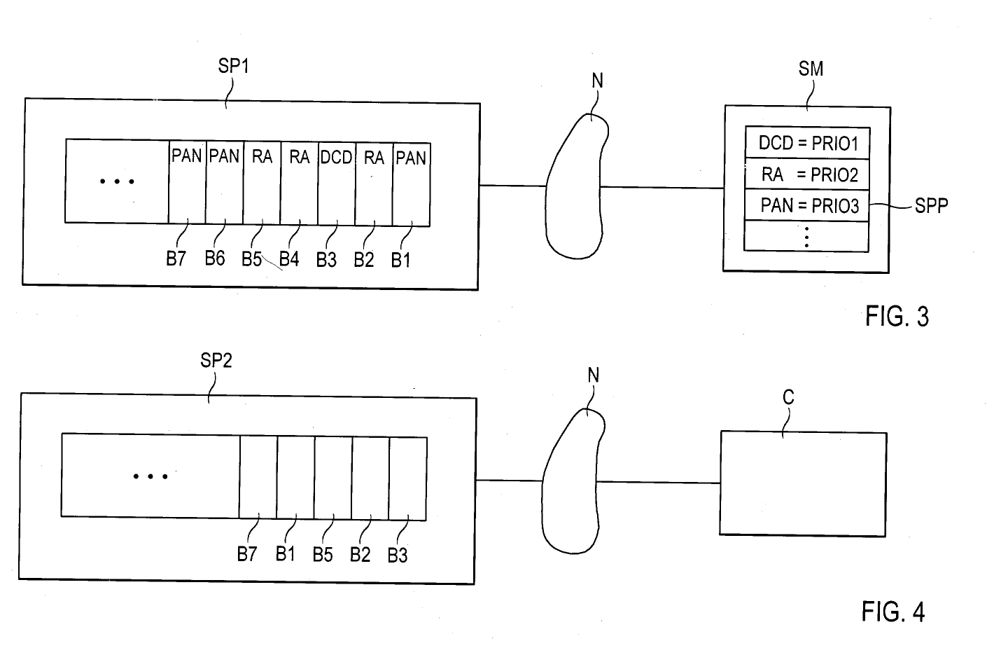

Pursuant to the invention, it is possible to assign to the different properties of the images different priorities for rejecting the images in a predetermined sequence if the presence or absence of the respective properties cannot be determined unambiguously by the determination means FM. For this purpose, a Table is stored in a memory SPP of the control means SM (see FIG. 3). According to this Table, a first priority PRIO1 is assigned to a first property DCD, for example, an improper orientation of the image, which may be relevant for the output of the assigned image data on a CD. A second priority PRIO2 is assigned to a second property RA, e.g. the presence of red eyes in the image; and a third priority PRIO3 is designed to a third property PAN, e.g. the presence of a 35 mm panoramic format.

A plurality of sets of image data which are stored in the first memory SP1 are shown in FIG. 3. The different sets of image data in each case contain those image data which are assigned to an image of a photographic order. In FIG. 3, the image data of a first image B1, a second image B2, a third image B3, a fourth image B4, a fifth image B5, a sixth image B6 and a seventh image B7 are shown by way of example. The image processing by the processing algorithms of the control means SM, to which the image data of the different images B1 to B7 was subjected, has noted certain properties of these images. The first image B1, for example, is an image with a panoramic format, the second image B2 is an image with red eyes, the third image B3 is an image, the orientation of which is incorrect for output on the CD station CD, the fourth image B4 is an image with red eyes, the fifth image B5 also is an image with red eyes, the sixth image B6 is an image with a panoramic format, and the seventh image B7 is also an image with a panoramic format. For the fourth image B4, the determination means FM determined the presence of red eyes unambiguously. For the sixth image B6, the determination means FM determined the presence of the panoramic format unambiguously. The fourth image B4 and the sixth image B6 are therefore not rejected by the sorting means AS, and they are processed in the conventional manner without being sent to the inspection station C. For the remaining images B1, B2, B3, B5 and B7, the determination means FM was unable to determine the respective properties unambiguously. It is therefore not certain whether the respective properties of those images actually are present. The presence of these properties can therefore be determined advantageously by rejecting these images and passing them on to the inspection station C.

In addition, a priority for passing the rejected images to the inspection station C is assigned by the control means SM to the images. This assignment takes place according to the Table stored in the memory SP. Therefore, in the present example of FIG. 3, the priority PRIO3 is assigned to image B1, the priority PRIO2 to image B2, the priority PRIO1 to the third image B3, the priority PRIO2 to the fifth image B5 and the priority PRIO3 to the seventh image B7. The image data sets of the individual images are classified in the second memory SP2 in accordance with the priority assigned.

FIG. 4 shows an example of a list of image data sets, which are stored in the second memory SP2 in accordance with the priority assigned to them by the control means SM. FIG. 4 therefore shows the image data sets of images B3, B2, B5, B1 and B7, which are stored in this sequence in the second memory SP2.

The image data sets of images B4 and B6 are not stored in memory SP2 since they are not transferred to the inspection station C. The data sets in the second memory SP2 are transferred over the network N to the inspection station C in accordance with their sequence in this memory SP2.

Advantageously, different criteria can be combined in any manner for flexibly establishing the images which are to be rejected. This can be done automatically. The criteria may be the above-described determination of priorities, the establishment of threshold values and/or the setting of the maximum number of images which can be stored in memory SP2. The rejection rate advantageously can be set easily by these criteria.

It is possible, even subsequently, to change the sequence in which the image data sets have been stored in the second memory SP2. The priority sequence which has been established in the Table of the memory SPP preferably can be changed at any time. In this way, it is possible to achieve flexibility and adaptation to different application cases.

Moreover, even after an image data set has been classified in the list of the memory SP2, it is possible to take the image data set out of the list in order to pass on the associated image data directly to the printer PR or the station CD for output. This may be beneficial if the printer PR does not have a sufficient number of digital image data available in order to ensure a continuous exposure on photographic paper. In this case, it may be more important for the operator of the system to have the printer PR run continuously and accept the possibility of an incorrect identification of a property of the image which is to be printed or stored.

1. Apparatus for processing images (B1-B7) of a photographic order, comprising
control means (SM) for controlling the processing, said control means including
determination means (FM) for determining the presence or absence of at least one property (PAN, RA, DCD) of the images (B1-B7) of the photographic order, and
sorting means (AS) for automatically rejecting an image from processing in the event that the presence or absence of said property cannot be determined unambiguously by the determination means (FM).

2. The apparatus of claim 1, including display means (MC), said control means (SM) causing the rejected image (B1-B7) to be displayed on said display device.

3. The apparatus of claim 2, wherein the display device (MC) comprises a monitor.

4. The apparatus of claim 2, including processing means (TC) for enabling the rejected image (B1-B7) to be processed by an operator.

5. The apparatus of claim 1, including means for setting ranges (S1-S4) for determining whether the presence or absence of the property (PAN, RA, DCD) can be determined unambiguously.

6. The apparatus of claim 5, wherein said ranges are set by at least one threshold value (S1-S4).

7. The apparatus of claim 1, wherein said sorting means (AS) automatically rejects an image (B1-B7) as a function of at least one additional criterion.

8. The apparatus of claim 1, wherein said sorting means establishes a rejection rate for the automatic rejection of several of the images (B1-B7).

9. The apparatus of claim 8, wherein the rejection rate for the automatic rejection of several of the images (B1-B7) is established on the basis of use by the operator.

10. The apparatus of claim 1, wherein the sorting means (AS) suspends the rejection regardless of the determination of the presence or absence of the property (PAN, RA, DCD) of one or more of the images (B1-B7) if the control means (SM) indicates that further processing of the images (B1-B7) of the photographic order is required.

11. The apparatus of claim 1, wherein the determination means (FM) determines the presence or absence of several properties (PAN, RA, DCD) of the images (B1-B7) of the photographic order and establishes a priority (Prio1-Prio3) of the several properties (PAN, RA, DCD) so that the automatic rejection can be carried out as a function of the established priority (Prio1-Prio3). 12. A method for processing the images (B1-B7) of a photographic order, wherein the processing is controlled by a control means (SM), comprising
determining the presence or absence of at least one property (PAN, RA, DCD) of at least one of the images (B1-B7) of said photographic order, and
rejecting one of the images (B1-B7) from the image processing step in the event that the presence of absence of said one property (PAN, RA, DCD) in said one image cannot be determined unambiguously.
